(19) United States
(12) Patent Application Publication
(10) Pub. No.: US 2024/0328802 A1
(43) Pub. Date: Oct. 3, 2024

(54) TRUST CALIBRATION

(71) Applicant: Honda Motor Co., Ltd., Tokyo (JP)

(72) Inventors: Teruhisa MISU, San Jose, CA (US); Shashank Kumar MEHROTRA, Campbell, CA (US); Zhaobo K. ZHENG, San Jose, CA (US); Kumar AKASH, Milpitas, CA (US)

(21) Appl. No.: 18/194,767

(22) Filed: Apr. 3, 2023

(51) Int. Cl. G01C 21/34; B60W 50/08; B60W 60/00

(52) U.S. Cl. CPC G01C 21/3484; B60W 50/082; B60W 60/001; G01C 21/3438

(57) ABSTRACT

According to one aspect, a system for trust calibration may include a processor and a memory. The memory may store one or more instructions. The processor may execute one or more of the instructions stored on the memory to perform one or more acts, actions, or steps, such as receiving a record of one or more interactions between a user and a first autonomous device, building a trust profile for the user based on one or more of the interactions between the user and the first autonomous device, and operating a target autonomous device based on the trust profile.

### BACKGROUND

Autonomous vehicles (AV) may be appealing due to benefits and on-demand ride services. Automakers are currently focusing on the development of shared autonomous vehicles (SAVs). The expected release of SAVs before privately-owned AV may be a consequence of the development and production costs of these vehicles, as well as the recent interest and innovations in shared mobility. Although SAVs may become widely available, not all shared mobility services may immediately provide high or full autonomy, but several services may remain partially automated. Regardless of the level of automation, one aspect of SAV adoption may be calibrating consumer trust in a mode of transport.

### BRIEF DESCRIPTION

According to one aspect, a system for trust calibration may include a processor and a memory. The memory may store one or more instructions. The processor may execute one or more of the instructions stored on the memory to perform one or more acts, actions, or steps, such as receiving a record of one or more interactions between a user and a first autonomous device, building a trust profile for the user based on one or more of the interactions between the user and the first autonomous device, and operating a target autonomous device based on the trust profile.

The processor may perform receiving a record of one or more interactions between the user and a second autonomous device and building the trust profile for the user based on one or more of the interactions between the user and the second autonomous device. The first autonomous device or the target autonomous device may be an autonomous vehicle. The record of one or more interactions may include a record of times between one or more of the interactions. An amount of time between a first interaction of one or more of the interactions and a second interaction of one or more of the interactions less than a threshold amount of time may create an association between the first interaction and the second interaction as a set of micro-interactions. An amount of time between a first interaction of one or more of the interactions and a second interaction of one or more of the interactions greater than a threshold amount of time may create a distinction between the first interaction and the second interaction as separate interactions. The record of one or more of the interactions between the user and the first autonomous device may be received from a mobile device. The operating the target autonomous device based on the trust profile may include selecting a mode of operation for the target autonomous device. The record of one or more interactions may include a number of interactions between the user and the first autonomous device. The record of one or more interactions may include a number of interaction types between the user and the first autonomous device.

According to one aspect, a system for trust calibration may include a processor and a memory. The memory may store one or more instructions. The processor may execute one or more of the instructions stored on the memory to perform one or more acts, actions, or steps, such as receiving a trust profile and a record of one or more interactions between a user and a first autonomous device, updating the trust profile for the user based on one or more of the interactions between the user and the first autonomous device, and operating a target autonomous device based on the trust profile.

The processor may perform receiving a record of one or more interactions between the user and a second autonomous device and updating the trust profile for the user based on one or more of the interactions between the user and the second autonomous device. The first autonomous device or the target autonomous device may be an autonomous vehicle. The record of one or more interactions may include a record of times between one or more of the interactions. An amount of time between a first interaction of one or more of the interactions and a second interaction of one or more of the interactions less than a threshold amount of time may create an association between the first interaction and the second interaction as a set of micro-interactions. An amount of time between a first interaction of one or more of the interactions and a second interaction of one or more of the interactions greater than a threshold amount of time may create a distinction between the first interaction and the second interaction as separate interactions.

According to one aspect, a computer-implemented method for trust calibration may include receiving a record of one or more interactions between a user and a first autonomous device, building a trust profile for the user based on one or more of the interactions between the user and the first autonomous device, and operating a target autonomous device based on the trust profile.

The first autonomous device or the target autonomous device may be an autonomous vehicle. The record of one or more interactions may include a record of times between one or more of the interactions. An amount of time between a first interaction of one or more of the interactions and a second interaction of one or more of the interactions less than a threshold amount of time may create an association between the first interaction and the second interaction as a set of micro-interactions.

### BRIEF DESCRIPTION OF THE DRAWINGS

FIG. 1 is an exemplary component diagram of a system for trust calibration, according to one aspect.

FIG. 2 is an exemplary flow diagram of a computer-implemented method for trust calibration, according to one aspect.

FIG. 3 is an illustration of an example computer-readable medium or computer-readable device including processor-executable instructions configured to embody one or more of the provisions set forth herein, according to one aspect.

FIG. 4 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

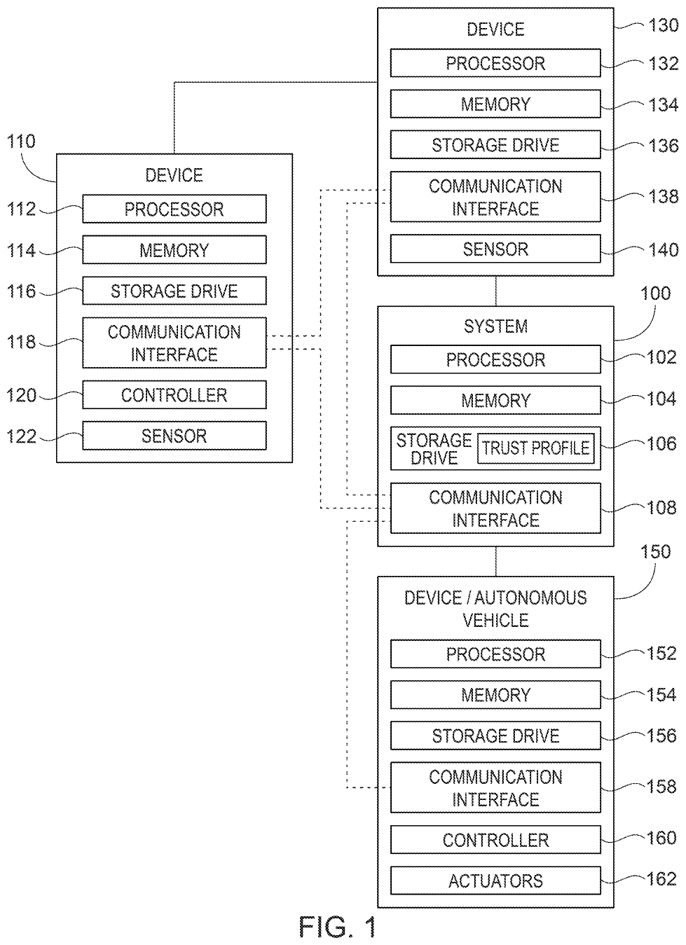

FIG. 1 is an exemplary component diagram of a system 100 for trust calibration, according to one aspect. The system 100 for trust calibration may include a processor 102, a memory 104, a storage drive 106, and a communication interface 108. The system 100 for trust calibration may communicate with one or more other devices, such as device 110, device 130, or device 150, via the communication interface 108. The device 110 may include a processor 112, a memory 114, a storage drive 116, a communication interface 118, a controller 120, and a sensor 122. The device 130 may include a processor 132, a memory 134, a storage drive 136, a communication interface 138, a controller 140, and a sensor 142. The device 150 may include a processor 152, a memory 154, a storage drive 156, a communication interface 158, a controller 160, and actuators 162.

Based on the communications indicative of the user's interaction with one or more of the devices 110, 130, 150, the system 100 for trust calibration may build or update a trust profile, which may be stored in the storage drive 106. Stated another way, the processor 102 of the system 100 for trust calibration may build or update the trust profile based on one or more interactions the user has with one or more of the devices 110, 130, 150 and/or one or more aspects related to one or more of the respective interactions. In may be noted that components of each of the devices 110, 130, 150 may be interconnected via one or more busses and the respective components may be operably connected to one another via the busses. Similarly, the respective communication interfaces 108, 118, 138, 158 may provide operable connections as shown in the dashed lines of FIG. 1, thereby enabling computer communication between respective devices 110, 130, 150, and the system 100 for trust calibration. The communication interface 108, 118, 138, 158 may each include a transmitter, a receiver, a transceiver, etc.

As described herein, the system 100 for trust calibration may interface or be in computer communication with one or more of the devices 110, 130, 150. According to one aspect, device 110 may be a mobile device linked to device 130, which may be a first autonomous device (e.g., an autonomous vehicle, scooter, etc.). The device 110 may receive interaction data indicative of user interactions (e.g., via the sensor 122) between the user and the device 130 and pass this data to the system 100 for trust calibration. The system 100 for trust calibration may utilize this data to drive or operate the device 150, which may be a target autonomous device (e.g., an autonomous vehicle, scooter, etc.).

According to one aspect, the system 100 for trust calibration may include the processor 102 and the memory 104. The memory 104 may store one or more instructions. The processor 102 may execute one or more of the instructions stored on the memory to perform one or more acts, actions, or steps. For example, the processor 102 may perform receiving a record of one or more interactions between a user and a first autonomous device (e.g., device 130) and building a trust profile for the user based on one or more of the interactions between the user and the first autonomous device. Additionally, processor 102 may perform receiving a record of one or more interactions between the user and a second autonomous device (e.g., device 150) and building the trust profile for the user based on one or more of the interactions between the user and the second autonomous device.

The trust profile may be indicative of how much or how little a user is estimated to trust autonomous technology or devices. This trust profile may have a trust score which may be lowered, for example, if the user has not interacted with autonomous devices recently (e.g., within a threshold period of time). Additionally, the trust score of the trust profile may be lowered if the user has met a threshold number of interactions with autonomous devices within a predetermined time window. Further, the trust profile may be assigned a lower trust score if the user has provided greater than a threshold number of autonomous disengage actions within a predetermined time window.

According to one aspect, the record of one or more interactions may be received directly from the device 130 and associated sensors 140. Alternatively, the device 110 may be a mobile device (e.g., mobile phone, smartwatch) linked to the device 130 and the record of one or more interactions may be received from the device 110, which may act as an intermediary. In this way, the record of one or more of the interactions between the user and the first autonomous device may be received from a mobile device.

In any event, the record of one or more of the interactions may include metadata or data pertaining to one or more interactions between the user and one or more devices 110, 130, 150. The system may identify interactions of interest based on whether the user was interacting with devices 110, 130, 150 acting in an autonomous fashion or while operating in an autonomous mode. Further, the record of one or more of the interactions may include a number of interactions between the user and the first autonomous device, a number of interactions between the user and the second autonomous device, a number of interaction types between the user and the first autonomous device, a number of interaction types between the user and the second autonomous device, etc. An example of an interaction type may include a command from the user to the respective autonomous device, a corrective action taken by the user, an emergency action taken by the user, a disengage autonomous mode command, an engage autonomous mode command, etc.

As another example, the record of one or more interactions may include a record of times between one or more of the interactions. An amount of time between a first interaction of one or more of the interactions and a second interaction of one or more of the interactions less than a threshold amount of time may create an association between the first interaction and the second interaction as a set of micro-interactions. An amount of time between a first interaction of one or more of the interactions and a second interaction of one or more of the interactions greater than a threshold amount of time may create a distinction between the first interaction and the second interaction as separate interactions. In this way, one or more different threshold amount of times may be utilized to define the number of interactions between the user and any of the first autonomous device, the second autonomous device, etc.

According to one aspect, the larger a gap is between the first interaction of one or more of the interactions and the second interaction of one or more of the interactions, the less trust the user may have with regard to interactions with autonomous devices in general. Therefore, the trust score of the trust profile may be lowered if the user has a number of interactions with greater than a predetermined amount of time between interactions (e.g., a large gap between interactions or an interaction gap). An interaction gap may be defined as a significant period of time (e.g., one week) between subsequent uses of an automated system, automated devices, autonomous devices, etc. A transition gap (e.g., one day, one hour) may be defined as a brief period of time less than the interaction gap between subsequent uses of an automated system. One interaction may include two or more micro-interactions joined together by one or more transition gaps. In this way, one or more different threshold amount of times may be utilized to define the number of interactions between the user and any of the first autonomous device, the second autonomous device, etc. According the one aspect, the gap associated with the most recent interaction may weighted heavier than gaps associated with less recent interactions.

The processor 102 may perform operating a target autonomous device (e.g., device 150, the target autonomous device may be the same device as the second autonomous device or a different device then the second autonomous device) based on the trust profile. The operating the target autonomous device based on the trust profile may include selecting a mode of operation for the target autonomous device. For example, if the device 150 is an autonomous device, such as an autonomous vehicle, the system may select the mode of operation to be aggressive, cautious (e.g., slower operation velocity and acceleration), request additional confirmation (e.g., request confirmation prior to performing a maneuver), provide additional transparency information (e.g., provide advance notice of braking, acceleration, turning, or other maneuvers), adjust a level of automation, etc. The device 130 and the device 150 may include one or more vehicle systems, the controller 160, and actuators 162, as described above. The processor 102 may control operation of the device 150 (e.g., target autonomous vehicle) via the controller 160 (or controller 120) driving the actuators 162 based on the trust profile, as created and updated above.

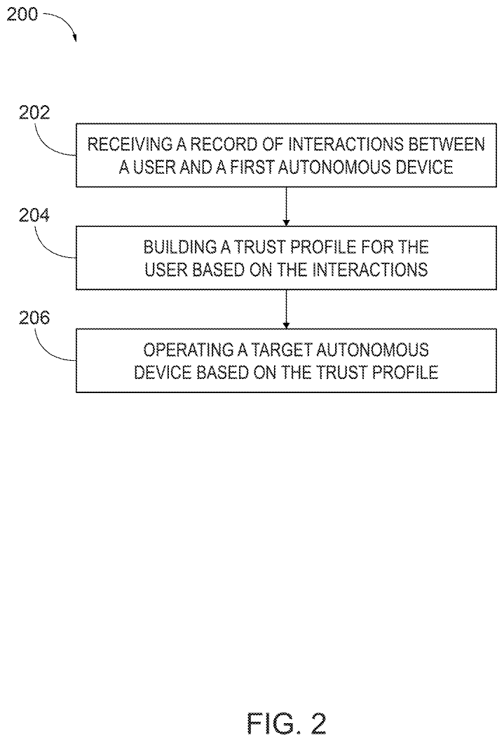

FIG. 2 is an exemplary flow diagram of a computer-implemented method 200 for trust calibration, according to one aspect. The computer-implemented method 200 for trust calibration may include receiving 202 a record of one or more interactions between a user and a first autonomous device, building 204 a trust profile for the user based on one or more of the interactions between the user and the first autonomous device, and operating 206 a target autonomous device based on the trust profile. The operating 206 the target autonomous device based on the trust profile may include selecting a mode of operation for the target autonomous device. Additionally, the computer-implemented method 200 for trust calibration may include receiving a record of one or more interactions between the user and a second autonomous device and building the trust profile for the user based on one or more of the interactions between the user and the second autonomous device. The first autonomous device, the second autonomous device, or the target autonomous device may be an autonomous vehicle.

The record of one or more interactions may be received from a mobile device. The record of one or more interactions may include a number of interactions between the user and the first autonomous device, a number of interactions between the user and the second autonomous device, a number of interaction types between the user and the first autonomous device, a number of interaction types between the user and the second autonomous device, a record of times between one or more of the respective interactions, etc. According to one aspect, an amount of time between a first interaction of one or more of the interactions and a second interaction of one or more of the interactions less than a threshold amount of time may create an association between the first interaction and the second interaction as a set of micro-interactions. Conversely, an amount of time between a first interaction of one or more of the interactions and a second interaction of one or more of the interactions greater than a threshold amount of time may create a distinction between the first interaction and the second interaction as separate interactions.

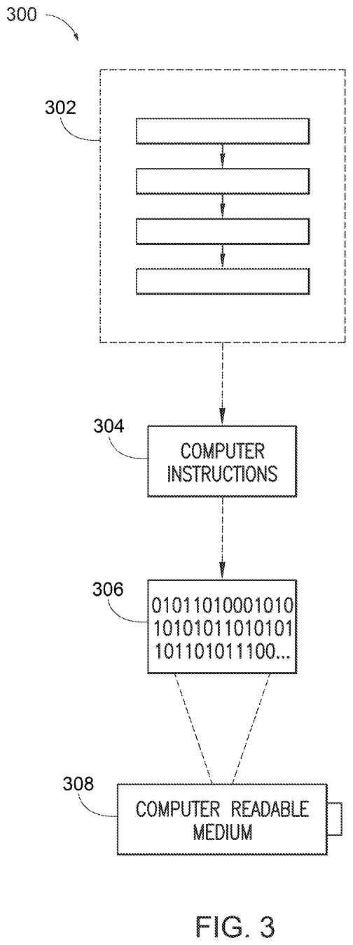

Still another aspect involves a computer-readable medium including processor-executable instructions configured to implement one aspect of the techniques presented herein. An aspect of a computer-readable medium or a computer-readable device devised in these ways is illustrated in FIG. 3, wherein an implementation 300 includes a computer-readable medium 308, such as a CD-R, DVD-R, flash drive, a platter of a hard disk drive, etc., on which is encoded computer-readable data 306. This encoded computer-readable data 306, such as binary data including a plurality of zero's and one's as shown in 306, in turn includes a set of processor-executable computer instructions 304 configured to operate according to one or more of the principles set forth herein. In this implementation 300, the processor-executable computer instructions 304 may be configured to perform a method 302, such as the computer-implemented method 200 of FIG. 2. In another aspect, the processor-executable computer instructions 304 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

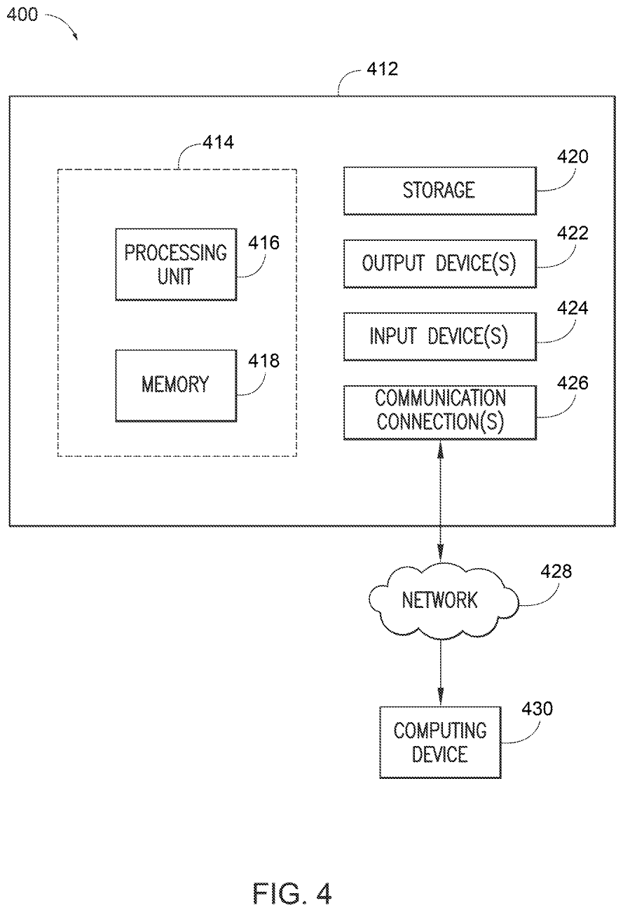

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for trust calibration, comprising:
a memory storing one or more instructions;
a processor executing one or more of the instructions stored on the memory to perform:
receiving a record of one or more interactions between a user and a first autonomous device;
building a trust profile for the user based on one or more of the interactions between the user and the first autonomous device; and
operating a target autonomous device based on the trust profile.

2. The system for trust calibration of claim 1, wherein the processor performs:
receiving a record of one or more interactions between the user and a second autonomous device; and
building the trust profile for the user based on one or more of the interactions between the user and the second autonomous device.

3. The system for trust calibration of claim 1, wherein the first autonomous device or the target autonomous device is an autonomous vehicle.

4. The system for trust calibration of claim 1, wherein the record of one or more interactions includes a record of times between one or more of the interactions.

5. The system for trust calibration of claim 4, wherein an amount of time between a first interaction of one or more of the interactions and a second interaction of one or more of the interactions less than a threshold amount of time creates an association between the first interaction and the second interaction as a set of micro-interactions.

6. The system for trust calibration of claim 4, wherein an amount of time between a first interaction of one or more of the interactions and a second interaction of one or more of the interactions greater than a threshold amount of time creates a distinction between the first interaction and the second interaction as separate interactions.

7. The system for trust calibration of claim 1, wherein the record of one or more of the interactions between the user and the first autonomous device is received from a mobile device.

8. The system for trust calibration of claim 1, wherein the operating the target autonomous device based on the trust profile includes selecting a mode of operation for the target autonomous device.

9. The system for trust calibration of claim 1, wherein the record of one or more interactions includes a number of interactions between the user and the first autonomous device.

10. The system for trust calibration of claim 1, wherein the record of one or more interactions includes a number of interaction types between the user and the first autonomous device.

11. A system for trust calibration, comprising:
a memory storing one or more instructions;
a processor executing one or more of the instructions stored on the memory to perform:
receiving a trust profile and a record of one or more interactions between a user and a first autonomous device;
updating the trust profile for the user based on one or more of the interactions between the user and the first autonomous device; and
operating a target autonomous device based on the trust profile.

12. The system for trust calibration of claim 11, wherein the processor performs:
receiving a record of one or more interactions between the user and a second autonomous device; and
updating the trust profile for the user based on one or more of the interactions between the user and the second autonomous device.

13. The system for trust calibration of claim 11, wherein the first autonomous device or the target autonomous device is an autonomous vehicle.

14. The system for trust calibration of claim 11, wherein the record of one or more interactions includes a record of times between one or more of the interactions.

15. The system for trust calibration of claim 14, wherein an amount of time between a first interaction of one or more of the interactions and a second interaction of one or more of the interactions less than a threshold amount of time creates an association between the first interaction and the second interaction as a set of micro-interactions.

16. The system for trust calibration of claim 14, wherein an amount of time between a first interaction of one or more of the interactions and a second interaction of one or more of the interactions greater than a threshold amount of time creates a distinction between the first interaction and the second interaction as separate interactions.

17. A computer-implemented method for trust calibration, comprising:
receiving a record of one or more interactions between a user and a first autonomous device;
building a trust profile for the user based on one or more of the interactions between the user and the first autonomous device; and
operating a target autonomous device based on the trust profile.

18. The computer-implemented method for trust calibration of claim 17, wherein the first autonomous device or the target autonomous device is an autonomous vehicle.

19. The computer-implemented method for trust calibration of claim 17, wherein the record of one or more interactions includes a record of times between one or more of the interactions.

20. The computer-implemented method for trust calibration of claim 17, wherein an amount of time between a first interaction of one or more of the interactions and a second interaction of one or more of the interactions less than a threshold amount of time creates an association between the first interaction and the second interaction as a set of micro-interactions.
